(19) United States
(12) Patent Application Publication
(10) Pub. No.: US 2026/0066417 A1
(43) Pub. Date: Mar. 5, 2026

(54) ELECTRIC VEHICLE (EV) BATTERY CONFIGURATION

(71) Applicant: The Regents of the University of Michigan, Ann Arbor, MI (US)

(72) Inventors: Andrew J. Dailey, Branchburg, NJ (US); Evan J. Branson, Ann Arbor, MI (US)

(21) Appl. No.: 19/314,043

(22) Filed: Aug. 29, 2025

Related U.S. Application Data
(60) Provisional application No. 63/688,616, filed on Aug. 29, 2024.

(51) Int. Cl. H01M 50/227; B60L 50/64; B60L 58/26; H01M 10/613; H01M 10/625; H01M 10/643; H01M 10/653; H01M 10/6554; H01M 50/213; H01M 50/224; H01M 50/249

(52) U.S. Cl. CPC H01M 50/227; B60L 50/64; H01M 10/613; H01M 10/625; H01M 10/643; H01M 10/653; H01M 10/6554; H01M 50/213; H01M 50/224; H01M 50/249; B60L 58/26; B60L 2200/32; H01M 2220/20

(57) ABSTRACT

An electric vehicle (EV) battery configuration is employable for use in numerous EV applications such as racing and recreational marine applications, automotive applications, and aerospace applications, among many other possibilities. In an implementation, the EV battery configuration has—as its main components—a metal frame, a first non-metal casing, a second non-metal casing, and a cooling plate. The first non-metal casing serves to support a multitude of first battery cells, and the second non-metal casing serves to support a multitude of second battery cells. The cooling plate has a location that is generally in-between the first non-metal casing and the second non-metal casing.

### CROSS-REFERENCE TO RELATED APPLICATION

This patent application claims the benefit of U.S. Provisional Patent Application No. 63/688,616, with a filing date of Aug. 29, 2024, the contents of which are hereby incorporated by reference in their entirety.

### TECHNICAL FIELD

This disclosure relates generally to electric vehicle (EV) battery configurations and, more particularly, relates to lightweight EV battery configurations and larger assemblies.

### BACKGROUND

Electric vehicle (EV) battery modules, such as lithium-ion battery modules, are typically made-up of a collection of lithium-ion cells connected together to form a larger EV battery pack. The modules are employed most widely in electric automobiles. Normally, a single EV battery pack is surrounded by a somewhat bulky aluminum housing enclosure. The aluminum housing enclosure can add up to thirty percent (30%) or more of the overall weight of the EV battery module. Cooling structures are commonly part of EV battery packs and housing enclosures, adding weight and constraining design potentialities.

### SUMMARY

In an embodiment, an electric vehicle (EV) battery configuration may include a metal frame, a first non-metal casing, a second non-metal casing, and a cooling plate. The metal frame is composed of a metal material. The first non-metal casing serves to support a multitude of first battery cells at a first interior thereof. The first non-metal casing is situated at a first side of the metal frame. The first non-metal casing has a first inward side. The first non-metal casing is composed of a non-metal material. The second non-metal casing serves to support a multitude of second battery cells at a second interior thereof. The second non-metal casing is situated at a second side of the metal frame. The second side is opposite the first side. The second non-metal casing has a second inward side. The second non-metal casing is composed of a non-metal material. The cooling plate is located between the first non-metal casing and the second non-metal casing at the first inward side and at the second inward side.

In an embodiment, an electric vehicle (EV) battery configuration may include a metal frame, a first non-metal casing, a second non-metal casing, and a cooling plate. The metal frame is composed of a metal material. An open central region resides in the metal frame. The first non-metal casing serves to support a multitude of first battery cells at a first interior thereof. The first non-metal casing is situated at a first side of the metal frame. The first non-metal casing is composed of a non-metal material. A first electrical insulation is established about the multitude of first battery cells by way of the first non-metal casing. The second non-metal casing serves to support a multitude of second battery cells at a second interior thereof. The second non-metal casing is situated at a second side of the metal frame. The second side is opposite the first side. The second non-metal casing is composed of a non-metal material. A second electrical insulation is established about the multitude of second battery cells by way of the second non-metal casing. The cooling plate is located between the first non-metal casing and the second non-metal casing. The cooling plate is located near, or at, the open central region of the metal frame.

In an embodiment, an electric vehicle (EV) battery configuration may include a metal frame, a first non-metal casing, a second non-metal casing, and a cooling plate. The metal frame is composed of a metal material. The first non-metal casing serves to support a multitude of first battery cells at a first interior thereof. The first non-metal casing is situated at a first side of the metal frame. The first non-metal casing has a first inward side. The first inward side is constituted by a first substantially open surface. The first non-metal casing has a first outward side. The first outward side is constituted by a first substantially closed surface. The first non-metal casing is composed of a non-metal material. The second non-metal casing serves to support a multitude of second battery cells at a second interior thereof. The second non-metal casing is situated at a second side of the metal frame. The second side is opposite the first side. The second non-metal casing has a second inward side. The second inward side is constituted by a second substantially open surface. The first non-metal casing has a second outward side. The second outward side is constituted by a second substantially closed surface. The second non-metal casing is composed of a non-metal material. The cooling plate is located between the first non-metal casing and the second non-metal casing at the first inward side and at the second inward side.

Further scope of applicability of the present disclosure will become apparent from the detailed description given hereinafter. But it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given below and the accompanying drawings, which are given by way of illustration only, and do not limit the present disclosure, and wherein:

FIG. 1 is a schematic depiction of an electric vehicle (EV) battery assembly having a multitude of EV battery configurations and that can be equipped in an electric vehicle such as an electric boat;

FIG. 2 is an exploded view of certain components of an embodiment of an EV battery configuration;

FIG. 3 is an exploded view of certain components of the EV battery configuration; and

FIG. 4 is a depiction of certain components of the EV battery configuration.

### DETAILED DESCRIPTION

Embodiments of an electric vehicle (EV) battery configuration 10 and larger assembly 12 are depicted in the figures and described herein. The EV battery configuration 10 and assembly 12 can be employed in use in various EV applications—and particularly those in which weight savings, increased capacity, and enhanced architectural design capabilities are increasingly in demand and sought—including racing and recreational marine applications, automotive applications, and aerospace applications, among many other possibilities. The EV battery configuration 10 exhibits an architecture unlike past EV battery modules. Main constructions of the EV battery configuration 10, per an embodiment, include a battery pack assembly 14 and a battery sandwich assembly 16. The design and construction of the battery pack assembly 14 is divorced, and separate and discrete, from that of accompanying structural and cooling necessities of the larger EV battery assembly 12. Rather, the battery sandwich assembly 16 furnishes structural integrity requirements of the EV battery configuration 10 and accommodates cooling constructions and components thereof. The EV battery configuration 10 has hence been designed and constructed to possess a minimized overall mass compared to past EV battery modules, as well as to furnish enhanced modularity among its assemblies and components, readying and easing subsequent performance of maintenance and service. The EV battery configuration 10 can be a lithium-ion battery configuration. Overall, a more efficient and effective EV battery configuration and architecture is provided. Still, a particular embodiment of the EV battery configuration and assembly may exhibit only one, or a combination of, the advancements set forth herein, none of the advancements, or other advancements not mentioned.

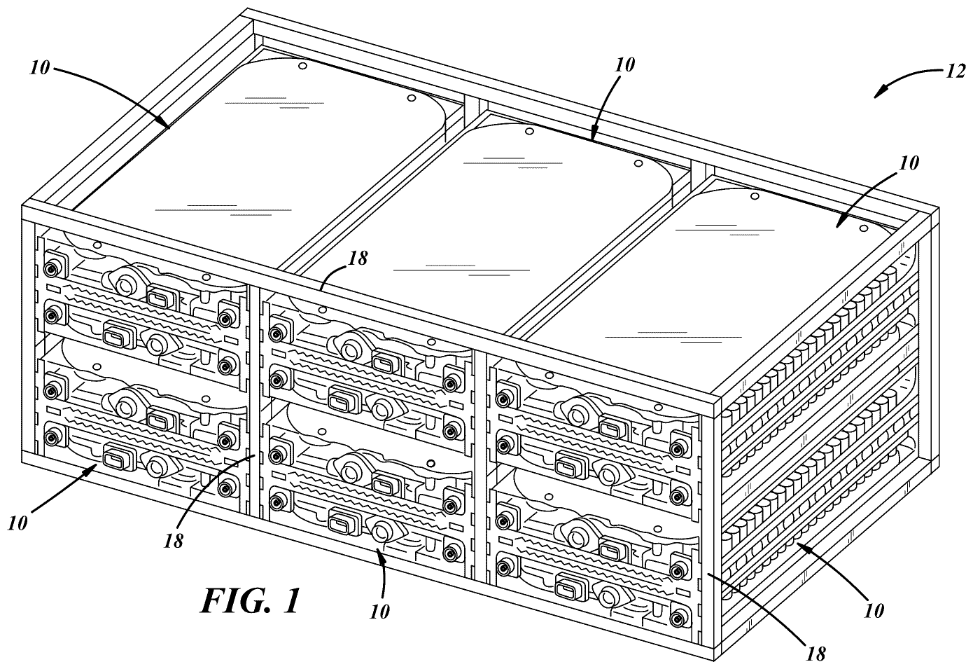

The EV battery configuration 10 can have various designs, constructions, and components in various embodiments, depending at least in part upon the application in which the EV battery configuration 10 will be employed and installed, as well as the intended EV battery capacity, among many other potential factors. In the embodiment of the figures, and with reference to FIG. 1, the larger EV battery assembly 12 has numerous support structures 18 that situate and brace a multitude of EV battery configurations 10 and battery pack assemblies 14 and battery sandwich assemblies 16. In the example of FIG. 1, there are a total of twelve battery pack assemblies 14, six battery sandwich assemblies 16, and four-thousand-six-hundred-and-eight (4,608) individual battery cells; still, in other embodiments and examples, other quantities of assemblies and cells can be provided. Further, in this example, the EV battery assembly 12 possesses a peak voltage of 800 volts (V), a capacity of 66 kilowatt-hours (kWh), and a peak momentary discharge of 1080 A, or 864 kW; still, in other embodiments and examples, other specifications can be provided.

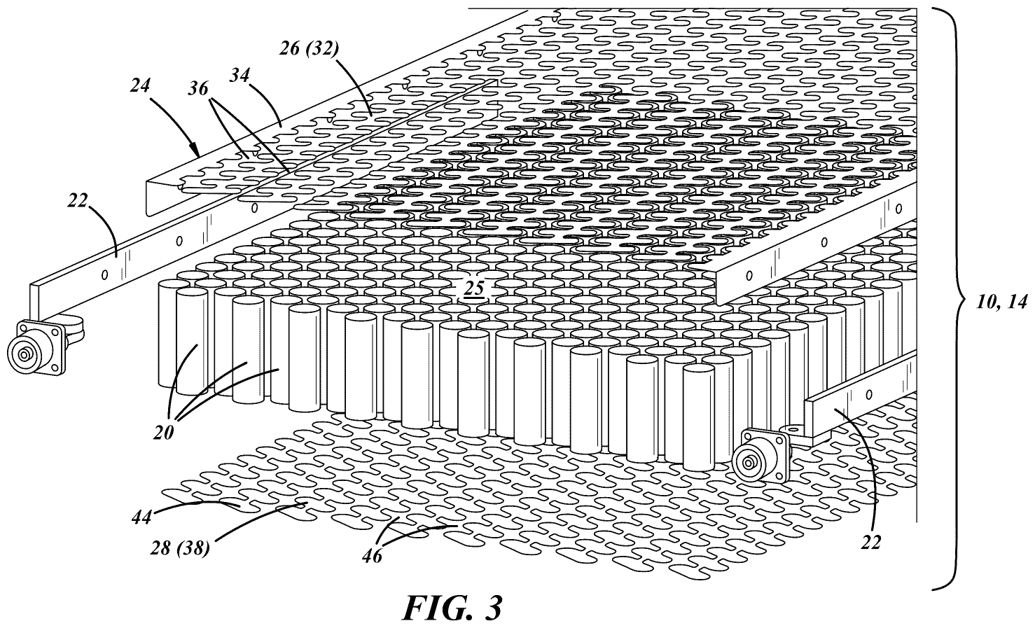

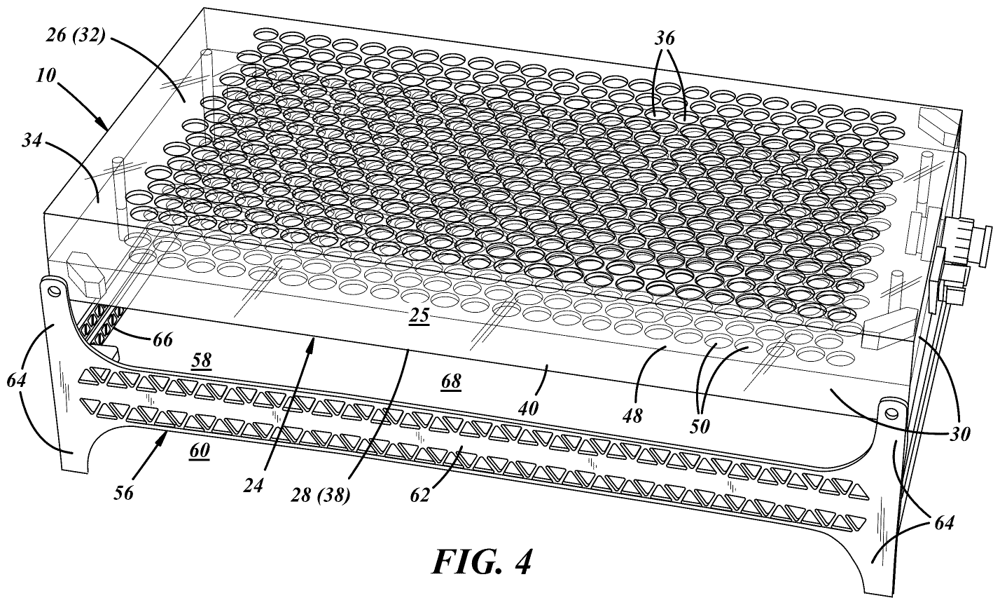

With reference to FIGS. 3 and 4, the battery pack assembly 14 serves to house and support a multitude of battery cells 20 and busbars 22 according to this embodiment. The battery pack assembly 14 can house and support other components and structures in various embodiments. In this embodiment, the battery pack assembly 14 includes a non-metal casing 24 that holds and houses and supports the battery cells 20 and busbars 22 at an interior 25 thereof. The battery cells 20 and busbars 22 are located at the interior 25. The interior 25 is established and defined by inwardly-facing surfaces of the non-metal casing 24. The battery cells 20 can be packed close together at the interior 25, and the busbars 22 can be attached and can extend along lateral sides of the closely-packed battery cells 20. The battery cells 20 can be arranged in rows of twenty-four in parallel, with sixteen in series; still, other arrangements and quantities are possible in other embodiments. The busbars 22 can be spot-welded to the battery cells 20 or attached via some other technique, and can be composed of an electrically conductive material such as a copper material, a NiSSCuSSNi material construction that is sold as SIGMACLAD® by the company Engineered Materials Solutions of Attleboro, MA USA, or can be composed and constructed of other materials. Further, in this example, the battery pack assembly 14 possesses a nominal voltage of 57.6 V; still, in other embodiments and examples, other voltages are possible.

The non-metal casing 24 can have various designs, constructions, and components in various embodiments. In this embodiment of FIGS. 3 and 4, the non-metal casing 24 can be composed wholly of a plastic material but it could have one or more non-plastic constructions and components in other embodiments. The plastic material can be acrylic, per an example, or can be another plastic material in another example. Still, in other embodiments the non-metal casing 24 can be composed of other non-metal materials such as carbon fiber, aerogels, Kevlar®, as well as other possibilities. Because of its material composition, per this embodiment, the non-metal casing 24 can establish an electrical insulation and electrical seal about the battery cells 20 and busbars 22 via the non-metal material. The non-metal casing 24 can have a number of walls that make-up its construction. The walls can be discrete with respect to one another, or can be unitary. Whether discrete or unitary, the walls can be composed of the non-metal material. The walls can exhibit a generally planar extent. In FIGS. 3 and 4, the non-metal casing 24 has a top wall 26, a bottom wall 28, and side walls 30. The top wall 26 constitutes an outward side 32 of the non-metal casing 24 relative to its arrangement when the battery pack assembly 14 is brought together and assembled with the battery sandwich assembly 16. If separate, the top wall 26 can be attached to one or more other walls of the non-metal casing 24 via bolting, snap-fit, and/or some other attachment technique. The top wall 26 can be constituted by a substantially closed surface 34. The substantially closed surface 34 can still exhibit a number of openings 36 residing therein that communicate with the interior 25. The openings 36 can have different shapes, sizes, and patterns. Still, the top wall 26 could be an entirely closed surface that lacks any voids or openings.

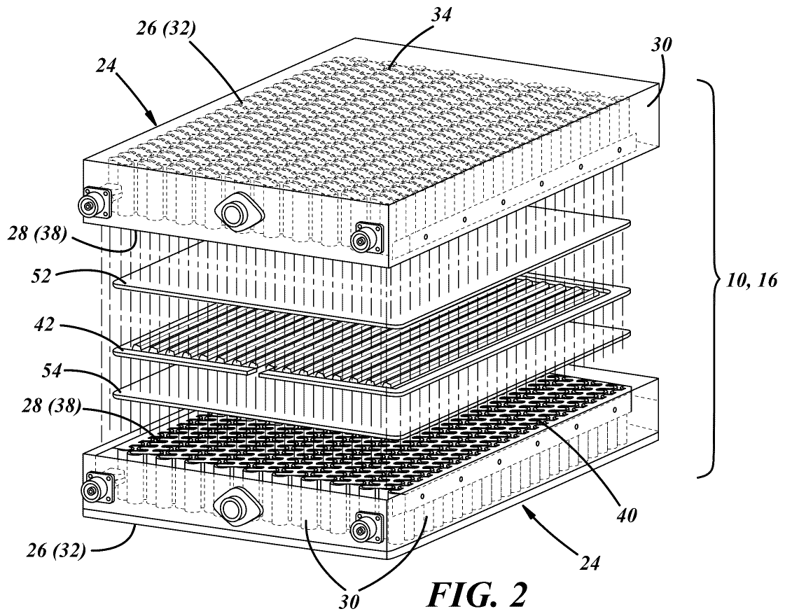

Further, the bottom wall 28 constitutes an inward side 38 of the non-metal casing 24 relative to its arrangement when the battery pack assembly 14 is brought together and assembled with the battery sandwich assembly 16. If separate, the bottom wall 28 can be attached to one or more other walls of the non-metal casing 24 via bolting, snap-fit, and/or some other attachment technique. The bottom wall 28 can be constituted by a substantially open surface 40. A large central opening can reside at the substantially open surface 40. The substantially open surface 40 accommodates location of a cooling plate 42 (FIG. 2) at the inward sides 38 of the non-metal casing 24 and facilitates thermal conduction from the battery cells 20 to the cooling plate 42. A non-metal plate 44 with openings 46 residing therein that communicate with the interior 25 can be provided at the inward side 38 and can further constitute the bottom wall 28. The non-metal plate 44, when provided, supports the battery cells 20 while still furnishing thermal conduction thereat. The non-metal plate 44 can be composed partly or wholly of a non-metal material, as described above. The openings 46 can have different shapes, sizes, and patterns. Furthermore, the terms top and bottom are used herein with respect to the orientation of the battery pack assembly 14 set forth in FIG. 3. But when assembled with the battery sandwich assembly 16, as demonstrated in FIG. 2, a pair of non-metal casings 24 can have opposite orientations with respect to each other such that the top wall 26 of the lowermost non-metal casing 24 of the pair is directed downward, and the bottom wall 28 of the lowermost non-metal casing 24 of the pair is directed upward.

With reference to FIG. 4, the non-metal casing 24 can further include an intermediate non-metal plate 48 situated at the interior 25. Relative to the top and bottom walls 26, 28, the intermediate non-metal plate 48 can be located about midway therebetween at the interior 25. The intermediate non-metal plate 48 supports and holds the battery cells 20. The intermediate non-metal plate 48 can be a structure separate from the other walls of the non-metal casing 24. It could be attached to one or more other walls of the non-metal casing 24 via bolting, snap-fit, and/or some other attachment technique. As described above, the intermediate non-metal plate 48 can be composed partly or wholly of a non-metal material. A multitude of pass-throughs 50 can reside in the intermediate non-metal plate 48 for insertion and reception of the battery cells 20. An individual pass-through 50 can be shaped and sized to accept insertion and reception of an individual battery cell 20.

With reference to FIG. 2, the battery sandwich assembly 16 serves to bring together a pair of battery pack assemblies 14 and a pair of non-metal casings 24 in a stacked arrangement with the cooling plate 42 and with first and second thermal conductor and/or electrical insulator pads 52, 54 located therebetween, according to this embodiment. The pair of battery pack assemblies 14 includes a first battery pack assembly and a second battery pack assembly, and the pair of non-metal casings 24 includes a first non-metal casing and a second non-metal casing; the first and second battery pack assemblies and non-metal casings can exhibit the same designs and constructions relative to each other, as described herein. Still, a multitude of battery pack assemblies 14 and non-metal casings 24 could be provided in the EV battery configuration, per an embodiment. However many there are, the battery pack assemblies 14 can be electrically coupled to one another via the battery sandwich assembly 16 or exterior thereof by way of a series electrical connection or a parallel electrical connection. The battery sandwich assembly 16 provides the structural integrity and support for the battery pack assemblies 14, as well as the mounting support for cooling constructions and components.

With reference to FIG. 4, in this embodiment the battery sandwich assembly 16 includes a metal frame 56. The metal frame 56 can have various designs, constructions, and components in various embodiments. In this embodiment of FIG. 4, the metal frame 56 is composed wholly of a metal material but it could have one or more non-metal constructions and components in other embodiments. The metal material can be a stainless steel, per an example, or can be another metal material in another example. The metal frame 56 constrains and supports the first battery pack assembly and first non-metal casing at a first side 58 thereof, and constrains and supports the second battery pack assembly and second non-metal casing at a second side 60 thereof. In the orientation of FIG. 4, the first side 58 is an upper side and the second side 60 is a lower side. Here, the first and second battery pack assemblies and non-metal casings are stacked one-on-top-of-the-other via the metal frame 56.

The metal frame 56 according to this embodiment is a rectangular-shaped metal frame with a one-piece construction. The construction can include discrete pieces attached together via welding or some other attachment technique, as an example. In FIG. 4, the metal frame 56 has a main peripheral rail portion 62 and a multitude of upright corner portions 64 projecting upward and downward from the main peripheral rail portion 62. The main peripheral rail portion 62 can constitute the primary body of the metal frame 56, while the upright corner portions 64 can constitute extremities thereof. The main peripheral rail portion 62 establishes a ledge 66 that extends around the metal frame 56 and projects inward thereof. The non-metal casing 24 can be seated on the ledge 66 in assembly, as well as the cooling plate 42 and first and second thermal conductors and/or electrical insulator pads 52, 54. A large central region 68 remains open and lacks structures of the metal frame 56. The large central open region 68 is established by the main peripheral rail portion 62 and the ledge 66. The large central open region 68 accommodates placement and location of the cooling plate 42 and first and second thermal conductors and/or electrical insulator pads 52, 54 in-between the stacked the first and second battery pack assemblies and non-metal casings.

At the in-between location, thermal conduction is facilitated from the battery cells 20 of both of the first and second battery pack assemblies and non-metal casings. Thermal conduction can further be provided by way of contact and connection of the metal frame 56 and the first and second non-metal casings; such contact and connection can be surface-to-surface contact and connection therebetween. Here, the metal frame 56 can serve as a heat sink. Furthermore, there are a total of eight upright corner portions 64 in this embodiment of the metal frame 56: four upward-projecting upright corner portions 64 at the four corners at the upper side of the metal frame 56, and likewise four downward-projecting upright corner portions 64 at the four corners at the lower side of the metal frame 56. Corners regions of the seated first and second battery pack assemblies and non-metal casings can be nestled at the upright corner portions 64 for support thereat in assembly of the EV battery configuration 10. Furthermore, in other embodiments, the metal frame 56 could be designed and constructed to wholly enclose the first and first and second battery pack assemblies and non-metal casings by its structures.

As shown in FIG. 2, the cooling plate 42 is located between non-metal casings 24 at inward sides 38 thereof. The cooling plate 42 is sandwiched between a pair of non-metal casings 24 according to this embodiment. The cooling plate 42 can be a metal cooling plate 42 composed of a metal material, or could be composed of other materials including but not limited to rubber, plastic, and/or silicone. Still, the cooling plate 42 could be made-up of less rigid constructions and structures. The cooling plate 42 can be attached and connected directly to the metal frame 56, although need not be. Furthermore, per an embodiment, the cooling plate 42 can be integrated with the metal frame 56 such that the cooling plate 42 and metal frame 56 constitute a monolithic and unitary structural component. Furthermore, the first and second thermal conductor and/or electrical insulator pads 52, 54 are similarly located between non-metal casings 24 at inward sides 38 thereof and sandwiched between the pair of non-metal casings 24, per the embodiment of FIG. 2. In another embodiment, the first and second thermal conductor and/or electrical insulator pads 52, 54 could have other forms including an integrated heat-spreader plate such as a thin piece of copper foil or the like extending over and along a surface or wall of the non-metal casings 24.

As used herein, the terms “general” and “generally” and “substantially” and “approximately,” as well as their grammatical variations, are intended to account for the inherent degree of variance and imprecision that is often attributed to, and often accompanies, any design and manufacturing process, including engineering tolerances—and without deviation from the relevant functionality and outcome—such that mathematical precision and exactitude is not implied and, in some instances, is not possible. In other instances, the terms “general” and “generally” and “substantially” and “approximately” are intended to represent the inherent degree of uncertainty and/or impossibility that is often attributed to any quantitative comparison, value, and measurement calculation, or other representation.

It is to be understood that the foregoing description is of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

Those of skill in the art will understand that modifications, additions, and/or removals of various components of the substances, formulations, apparatuses, methods, systems, and embodiments described herein may be made without departing from the full scope and spirit of the present disclosure, which encompass such modifications and any and all equivalents thereof.

1. An electric vehicle (EV) battery configuration, comprising:
a metal frame composed of a metal material;
a first non-metal casing that supports a plurality of first battery cells at a first interior thereof, said first non-metal casing situated at a first side of said metal frame, said first non-metal casing having a first inward side, and said first non-metal casing composed of a non-metal material;
a second non-metal casing that supports a plurality of second battery cells at a second interior thereof, said second non-metal casing situated at a second, opposite side of said metal frame with respect to said first non-metal casing, said second non-metal casing having a second inward side, and said second non-metal casing composed of a non-metal material; and
a cooling plate located between said first non-metal casing and said second non-metal casing at said first inward side and at said second inward side.

2. The electric vehicle (EV) battery configuration as set forth in claim 1, wherein said metal frame is a rectangular metal frame having a main peripheral rail portion and a plurality of upright corner portions projecting upward and downward from said main peripheral rail portion.

3. The electric vehicle (EV) battery configuration as set forth in claim 2, wherein a central region of said rectangular metal frame is open.

4. The electric vehicle (EV) battery configuration as set forth in claim 3, wherein said cooling plate is located between said first non-metal casing and said second non-metal casing adjacent said open central region of said rectangular metal frame.

5. The electric vehicle (EV) battery configuration as set forth in claim 2, wherein said first non-metal casing is seated at said main peripheral rail portion via upward-projecting upright corner portions of said plurality of upright corner portions, and said second non-metal casing is seated at said main peripheral rail portion via downward-projecting upright corner portions of said plurality of upright corner portions.

6. The electric vehicle (EV) battery configuration as set forth in claim 1, wherein a first electrical insulation is established about said plurality of first battery cells via said first non-metal casing, and a second electrical insulation is established about said plurality of second battery cells via said second non-metal casing.

7. The electric vehicle (EV) battery configuration as set forth in claim 1, wherein said first non-metal casing is composed wholly of the plastic material, and said second non-metal casing is composed wholly of the plastic material.

8. The electric vehicle (EV) battery configuration as set forth in claim 1, wherein said first non-metal casing has a first outward side, said first outward side being constituted by a first substantially closed surface, said first inward side being constituted by a first substantially open surface.

9. The electric vehicle (EV) battery configuration as set forth in claim 8, wherein said second non-metal casing has a second outward side, said second outward side being constituted by a second substantially closed surface, said second inward side being constituted by a second substantially open surface.

10. The electric vehicle (EV) battery configuration as set forth in claim 1, wherein said first non-metal casing includes a first intermediate non-metal plate that supports said plurality of first battery cells at said first interior, and said second non-metal casing includes a second intermediate non-metal plate that supports said plurality of second battery cells at said second interior.

11. The electric vehicle (EV) battery configuration as set forth in claim 1, further comprising a first busbar located at said first interior of said first non-metal casing, and a second busbar located at said second interior of said second non-metal casing.

12. The electric vehicle (EV) battery configuration as set forth in claim 1, further comprising a first thermal conductor and/or electrical insulator pad located between said first non-metal casing and said cooling plate at said first inward side, and a second thermal conductor and/or electrical insulator pad located between said second non-metal casing and said cooling plate at said second inward side.

13. The electric vehicle (EV) battery configuration as set forth in claim 1, wherein the EV battery configuration is a marine EV lithium-ion battery configuration.

14. The electric vehicle (EV) battery configuration as set forth in claim 1, further comprising a plurality of non-metal casings that support a plurality of battery cells at interiors thereof.

15. The electric vehicle (EV) battery configuration as set forth in claim 1, wherein said cooling plate is integrated with said metal frame such that said cooling plate and metal frame constitute a monolithic structural component.

16. The electric vehicle (EV) battery configuration as set forth in claim 1, wherein said metal frame partially or wholly encloses said first and second non-metal casings in assembly of the EV battery configuration.

17. The electric vehicle (EV) battery configuration as set forth in claim 1, wherein said metal frame provides thermal conduction for said first and second non-metal casings via contact thereamong amid use of the EV battery configuration.

18. An electric vehicle (EV) battery configuration, comprising:
a metal frame composed of a metal material, an open central region residing in said metal frame;
a first non-metal casing that supports a plurality of first battery cells at a first interior thereof, said first non-metal casing situated at a first side of said metal frame, said first non-metal casing composed of a non-metal material, a first electrical insulation being established about said plurality of first battery cells via said first non-metal casing;
a second non-metal casing that supports a plurality of second battery cells at a second interior thereof, said second non-metal casing situated at a second, opposite side of said metal frame with respect to said first non-metal casing, said second non-metal casing composed of a non-metal material, a second electrical insulation being established about said plurality of second battery cells via said second non-metal casing; and
a cooling plate located between said first non-metal casing and said second non-metal casing, said cooling plate located adjacent said open central region of said metal frame.

19. The electric vehicle (EV) battery configuration as set forth in claim 18, wherein said first non-metal casing has a first outward side and a first inward side, said first outward side being constituted by a first substantially closed surface, said first inward side being constituted by a first substantially open surface, and wherein said second non-metal casing has a second outward side and a second inward side, said second outward side being constituted by a second substantially closed surface, said second inward side being constituted by a second substantially open surface.

20. An electric vehicle (EV) battery configuration, comprising:
a metal frame composed of a metal material;
a first non-metal casing that supports a plurality of first battery cells at a first interior thereof, said first non-metal casing situated at a first side of said metal frame, said first non-metal casing having a first inward side, said first inward side being constituted by a first substantially open surface, said first non-metal casing having a first outward side, said first outward side being constituted by a first substantially closed surface, said first non-metal casing composed of a non-metal material;
a second non-metal casing that supports a plurality of second battery cells at a second interior thereof, said second non-metal casing situated at a second, opposite side of said metal frame with respect to said first non-metal casing, said second non-metal casing having a second inward side, said second inward side being constituted by a second substantially open surface, said second non-metal casing having a second outward side, said second outward side being constituted by a second substantially closed surface, said second non-metal casing composed of a non-metal material; and
a cooling plate located between said first non-metal casing and said second non-metal casing at said first inward side and at said second inward side.
